(19) United States
(12) Patent Application Publication
(10) Pub. No.: US 2009/0065451 A1
(43) Pub. Date: Mar. 12, 2009

(54) MANIFOLD AND FILTRATION SYSTEM

(75) Inventors: Pierre Nieuwland, Maassluis (NL); Timothy Droste, Howell, MI (US); Jeffrey Woodbury, Hillsdale, MI (US)

Correspondence Address: DOBRUSIN & THENNISCH PC, 29 W LAWRENCE ST, SUITE 210, PONTIAC, MI, 48342, US

(73) Assignee: NTZ Micro Filtration USA, INC.

(21) Appl. No.: 12/207,955

(22) Filed: Sep. 10, 2008

Related U.S. Application Data
(60) Provisional application No. 60/971,439, filed on Sep. 11, 2007.

(51) Int. Cl. B01D 29/88; B01D 35/30

(52) U.S. Cl. 210/808; 210/428

(57) ABSTRACT

The present invention is premised upon an improved filter device that has multiple flow paths with differing filtration performance. Access to the flow paths are controlled by pressure valves and are based upon the level of pressure within the system. The improved filter device is also tunable to the work life cycle of the system.

### CLAIM OF PRIORITY

The present application claims the benefit of the filing date of U.S. Provisional Application Ser. No. 60/971,439, filed Sep. 11, 2007, hereby incorporated by reference.

### FIELD OF THE INVENTION

The present invention relates generally to manifold and filter devices, and more particularly to a manifold and filtration device with a by-pass valve and method for filtering fluid.

### BACKGROUND OF THE INVENTION

It is well known that solid-particle contamination can damage mechanical systems. Two common types of contamination include Type I contamination and to a greater extent Type II contamination.

Type I contamination usually comprises substantially large particles having diameters larger than about 150 microns. This contamination can rapidly damage the systems and lead to early-life repairs.

Also, Type II contamination usually includes particles having diameters less than about 60 microns. These particles can be debris generated from component wear, as well as particles ground up from larger Type I particles. This contamination can cause erratic valve performance, poor cooling, inefficient lubrication, and accelerated degradation of the systems.

The Type II particles, which have diameters roughly within the 40 to 60 micron range, usually are removed from the fluid by coarse full-flow filters. These coarse filters typically have substantially low flow resistance.

Additionally, the Type II particles, which have diameters less than about 40 microns, can be removed from the systems by filtration devices. It is understood that this fiber material is sufficiently fine for filtering the small Type II particles from the systems.

Furthermore, the filtration devices each typically include a rigid housing and a filter cartridge that is clamped between the opposing ends of the housing. The filter cartridge usually is made of a fine, substantially deformable fiber material. Examples of this fiber material can include paper-like materials, felt-like materials, and glass-fiber materials.

Additionally, the fiber material's high resistance to flow creates a high pressure differential from an inlet surface to an outlet surface of the fiber material. This pressure differential typically is sufficiently high for compressing the deformable fiber material and collapsing the filter cartridge or may activate a filter by-pass mechanism.

It is also believed that the quantity and/or presence of the above mentioned particle may vary over the work life cycle of the mechanical system. For example, larger particles may be more prevalent during the initial start-up of the mechanical system and less so during the middle and end of its work life cycle.

The present invention addresses the above high pressure issue in a new and unique manner. The invention provides for tunable levels of fluid filtration depending upon the work life cycle stage of the filtered mechanical system, desired particle size, desired pressure levels within the filter, or any combination thereof.

Among the literature that may pertain to this technology include the following patent documents: U.S. Pat. No. 6,568,539; U.S. Pat. No. 5,830,371; and U.S. Pat. No. 5,569,373 all incorporated herein by reference for all purposes.

### SUMMARY OF THE INVENTION

The present invention seeks to improve the filtering of fluid under various differential pressure situations and work life scenarios.

Accordingly, pursuant to a first aspect of the present invention, there is contemplated a filter assembly, comprising: a) a housing including a wall structure defined to include at least a first filtering chamber and a second filtering chamber; b) a tube that spans a substantial portion of the housing defining an outlet flow path for a flow to exit the housing; the tube being ported for allowing fluid to enter therein from the first filtering chamber and the second filtering chamber; c) a valve in the inlet of a cap for allowing selective flow of fluid entering the inlet to enter either or both of the first or second filtering chamber; d) a valve between the first filtering chamber and the second filtering chamber for allowing selective flow of fluid between the first and the second filtering chamber; e) at least one first filter element in the first filtering chamber; f) at least one second filter element in the second filtering chamber; wherein fluid that enters the assembly is controllably routed by a valve into the first filtering chamber, the second filtering chamber, or both, where it is filtered and then passes into the tube for exiting the housing.

The invention of the first aspect may be further characterized by one or any combination of the features described herein, such as the first filtering chamber and the second filtering chamber being generally axially aligned; the second filtering chamber includes a plurality of different filter elements; the filter elements are axially aligned relative to each other and successively adjoin one other; the housing and the wall structure defining the chambers are generally cup-shaped; the filter surrounds the tube; the flow is controlled to allow selective flow between a first and second filter in the second chamber; the filter can is separated from the housing by a spring.

Accordingly, pursuant to a second aspect of the present invention, there is contemplated a method of filtering a fluid comprising the steps of: inputting the fluid into a multi-flow path filtering device under a pressure; filtering the fluid selectively via a flow path depending upon the pressure; and outputting the fluid from the multi-flow path filtering device.

### BRIEF DESCRIPTION OF THE DRAWINGS

FIG. 1 illustrates a sectional view of the present invention.

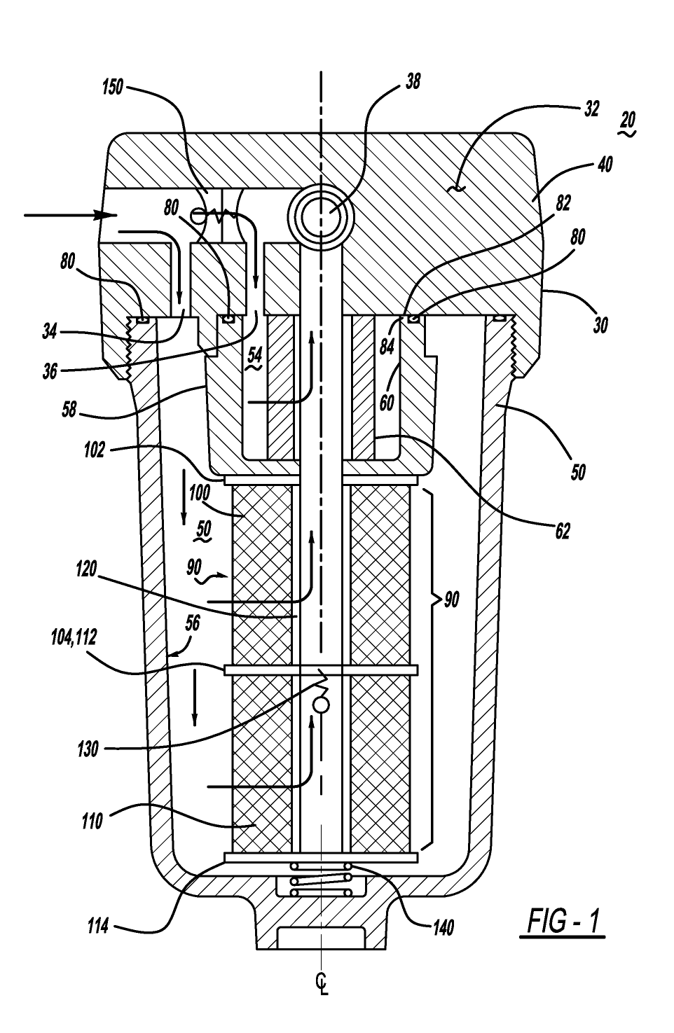

### DETAILED DESCRIPTION

The present invention is directed at an improved manifold and filter devices, and more particularly to a manifold and filtration device with a by-pass valve and method for filtering fluid. Any art suitable filter element or device, for example filter devices of U.S. Pat. No. 6,536,600 are herein incorporated by reference for all purposes and may be adapted for use herein.

The filter device 20 described herein may range in size from very small (e.g. less than 25 mm) to very large (e.g. more than 3 m) depending upon the mechanical system it is packaged to. The present invention contemplates that the filter device may be used on mechanical systems that range from large ships to small engines (e.g. lawn and garden equipment).

The filter device 20 contemplated includes a housing 30 defining a chamber with two distinct detachable sections 40, 50. The housing 30 interfaces with the source of the fluid (e.g. a motor) with a gasket or o-ring 80 for sealing the two surfaces 82, 84. The housing 30 includes a top section 32 that has at least two inlets 34, 36 and at least one outlet 38 for communication of a fluid to be filtered. A first inlet 34 allows for a fluid to flow under pressure to a lower section 50 of the chamber, the fluid flowing in between the chamber wall 56 and a set of filtering devices 90. A second inlet 36, which is controllably activated (e.g. via a by-pass valve 150), allows for a fluid flow to an upper section 54 of the chamber which is defined by a cup section 58 (safety screen shell), the fluid flowing in between a wall of the separate cup section 60 and a cup filtering device 62 (by-pass safety screen). In either section, for the fluid to pass to the outlet 38 it must pass through the respective filtering device 90. The by-pass valve 150 may be located at the interface between the at least two inlets 34, 36. The by-pass valve 150 may activate (e.g. allowing flow) once a specific pressure in the system as a whole has been reached, preferably at least about 240 psid, more preferably about 320 psid, and still more preferably at least about 400 psid.

The invention provides three distinct flow paths (indicated by the arrows) for the fluid, depending on the differential pressure in the system (between the inlet and the outlet).

Within the lower section 50 of the chamber, there are two filtering devices, top 100 and bottom 110, interfacing each other and with the top filter device 62 (by-pass safety screen) interfacing the bottom of the cup section and includes an opening to allow fluid flow.

The bottom and top filtering devices 100, 110 include top 102, 112 and bottom 104, 114 caps of fluid impermeable material and with a filtering material 106, 116 and core tube 120 located in-between. Fluid flows between the outer areas 52 of the lower chamber 50, through the filtering material of the respective filtering devices, into a core tube area 120. Located at the interface between the bottom and top filtering device core tubes is a valve 130 that allows fluid flow from the bottom filter device 100 once a specific pressure has been reached, preferably at least about 60 psid, more preferably about 80 psid, and still more preferably at least about 100 psid.

Below the bottom filtering device 100 and spanning the space between the device and the wall of the lower chamber 50 may be a spacer element 140. Preferably, this spacer element 140 comprises a spring that provides a vertical force to the assembly, aiding in holding the filtering device 90 in place.

This core tube 120 allows the fluid then to flow towards the cup section 60, and ultimately to the outlet 38, through the opening at the top filtering device/top cup interface. Flow between the filters in this section is controlled via pressure controlled check valve type device 130. The valve 130 opening pressure is set so that relative flow of fluid between the two filtering devices 100, 110 is controllable.

The above described filtering devices (e.g. cup filtering device 62, bottom and top filtering devices 100, 110) may include any number of filtering materials. They may include woven and non-woven materials, paper, glass fibers, pleated woven screen, pleated non directional fiber, and rolled UHE radial elements or combinations thereof. It is contemplated that any number of currently available filtering materials or not yet invented materials may be used in the present invention. Some examples of commercially available filtering materials include materials used in LyPore® line by Lydall.

In one preferred embodiment, the cup filtering device includes a woven screen element that at least filters or captures Type I contamination (e.g. particles), and more preferably filters even smaller contamination (e.g. particles as small as about 56 microns). The top filtering device 110, preferably filters very fine contamination (e.g. particles of about 3 microns or less), more preferably filtering smaller contamination (e.g. particles as small as 1-2 microns). Preferably, the top filter includes what is known as an Ultra High Efficiency element “UHE”. The bottom filtering device 100, preferably filters fine contamination (e.g. particles of about 28 microns or less), more preferably filtering smaller contamination (e.g. particles as small as 12 microns). Preferably, the bottom filter includes a pleated non-woven element, such as pleated micro glass.

It is also contemplated that the top and bottom filtering devices may be flip-flopped, such that the bottom filters very fine particles and the top filters more course particles.

It is contemplated that the above described filter device 20 may be “tunable” for a given work life cycle stage of the mechanical system being filtered. Work life cycles may be further described as:

Stage 1—Early Life (e.g. from initial build to about first 10% of life)—debris include large quantity of “Built-in” Type I contaminant, (150 micron and larger) and moderate amount of medium sized (40-150 micron ) debris, small amount of Type II (“fines”, 50 micron and smaller)

Stage 2—Mid life (e.g. about 10-80% of machine life)—predominantly wear and ingested debris, mostly medium size and increasing amounts of fines—both of these cause stable but steady wear out of sliding and rolling contact parts, e.g. bushing, pistons, bearings, splines, etc.

Stage 3—End of life (e.g. about last 20% before major overhauls)—increasing amounts of medium size debris as seals allow more ingests and wear rate accelerates

Post heavy repair stage—similar to Stage 1

Illustrative examples of tunable feature of the present invention for each work life stage are described below. This list is not to be considered as limiting and additional permutations are contemplated.

Tunable characteristics may be defined: Each filter assembly 20 (comprised of three filtering devices 62, 100, 110 and one valve 130) which can be designed to match mechanical system work life stages, to with:

Each of the filter devices 62, 100, 110 may be sized (length, number of pleats, pore size, wall thickness, etc.) too capturer the different type/size of debris (contamination) that characterizes different mechanical system work life stage. The valve 130 can be configured to activate at an appropriate psid value.

Stage 1 Example—an oversize cup filtering device 62 with pore size set at 80 micron, undersize UHE element (top filtering device 110), standard size pleated element (bottom filtering device 100), valve 130 set to favor pleated element (e.g. low differential pressure)—intent is to protect sensitive components from large Type I debris under all operating conditions.

Stage 2 Example—undersize cup filtering device 62 with larger pore size (120 micron) for cold operation, oversize UHE (top filtering device 110), standard size pleated element (bottom filtering device 100) with valve 130 set to favor UHE—intent is to minimize wear rate by cleaning fluid to high level

Stage 3 Example—Undersize cup filtering device 62 with larger pore size, undersize UHE (top filtering device 110) and oversize pleated element (bottom filtering device 100) to capture high wear rate and ingested debris—intent is to extend useful life until major overhaul

Post heavy repair Stage Example—use Stage 1 filter device 20

The present invention contemplates methods according to the teachings wherein the flow of fluids under various pressure conditions can be effectively filtered. The invention is used where heretofore the viscosity of some fluids where too great to allow effective filtering and the entire filtering system was by-passed.

Unless stated otherwise, the method depicted herein is not intended to be restrictive of the invention, and other dimensions or geometries are possible. In addition, while a feature of the present invention may have been described in the context of only one of the illustrated embodiments, such feature may be combined with one or more other features of other embodiments, for any given application.

The preferred embodiment of the present invention has been disclosed. A person of ordinary skill in the art would realize however, that certain modifications would come within the teachings of this invention. Therefore, the following claims should be studied to determine the true scope and content of the invention.

It is believed that the present invention may be distinguished from the presently know prior art by at least one or more of the claimed features. For example, none of the art presently known to the Applicant includes multiple filtering elements with at least one pressure valve to aid in the determination of how much flow occurs in each of the filtering elements.

What is claimed is:

1. A filter assembly, comprising:
a) a housing including a wall structure defined to include at least a first filtering chamber and a second filtering chamber;
b) a tube that spans a substantial portion of the housing defining an outlet flow path for a flow to exit the housing; the tube being ported for allowing fluid to enter therein from the first filtering chamber and the second filtering chamber;
c) a valve in the inlet of a cap for allowing selective flow of fluid entering the inlet to enter either or both of the first or second filtering chamber;
d) a valve between the first filtering chamber and the second filtering chamber for allowing selective flow of fluid between the first and the second filtering chamber;
e) at least one first filter element in the first filtering chamber;
f) at least one second filter element in the second filtering chamber;
wherein fluid that enters the assembly is controllably routed by a valve into the first filtering chamber, the second filtering chamber, or both, where it is filtered and then passes into the tube for exiting the housing.

2. The assembly of claim 1, wherein the first filtering chamber and the second filtering chamber being generally axially aligned.

3. The assembly of claim 1, wherein the second filtering chamber includes a plurality of different filter elements.

4. The assembly of claim 1, wherein the filter elements are axially aligned relative to each other and successively adjoin one other.

5. The assembly of claim 1, wherein the housing and the wall structure defining the chambers are generally cup-shaped.

6. The assembly of claim 1, wherein the filter surrounds the tube.

7. The assembly of claim 1, wherein the flow is controlled to allow selective flow between a first and second filter in the second chamber.

8. The assembly of claim 1, wherein the filter can is separated from the housing by a spring.

9. A method of filtering a fluid comprising the steps of:
inputting the fluid into a multi-flow path filtering device under a pressure;
filtering the fluid selectively via a flow path depending upon the pressure; and
outputting the fluid from the multi-flow path filtering device.
